(19) United States
(12) Patent Application Publication
(10) Pub. No.: US 2022/0388096 A1
(43) Pub. Date: Dec. 8, 2022

(54) HEALING ENERGY BEAM FOR SMOOTHENING SURFACE IRREGULARITIES IN WELD JOINTS

(71) Applicants: GM Global Technology Operations LLC, Detroit, MI (US); Penn State Research Foundation, University Park, PA (US)

(72) Inventors: Hui-ping Wang, Troy, MI (US); Joshua Lee Solomon, Berkley, MI (US); Zixuan Wan, Sterling Heights, MI (US); Nannan Chen, Sterling Heights, MI (US); Scott A. Hooker, Sterling Heights, MI (US)

(21) Appl. No.: 17/338,001

(22) Filed: Jun. 3, 2021

(51) Int. Cl. B23K 26/354; B23K 26/082; B23K 26/06; B23K 9/013; B23K 15/08

(52) U.S. Cl. CPC B23K 26/354; B23K 26/082; B23K 26/0643; B23K 9/013; B23K 15/08

(57) ABSTRACT

A method for healing surface irregularities in a weld joint includes generating a healing energy beam by a focused energy device, where the healing energy beam includes a predefined energy density. The method also includes scanning the healing energy beam along at least a portion of a periphery of the weld joint, where the weld joint includes at least an upper layer and a lower layer. The method also includes melting less than half a thickness of the upper layer of the weld joint. The predefined energy density of the healing energy beam is based on the thickness of the upper layer of the weld joint.

### INTRODUCTION

The present disclosure relates to a method and system for healing surface irregularities in a weld joint. More particularly, the present disclosure relates to a focused energy device that generates a healing energy beam that improves the appearance of a weld having surface irregularities.

While strength is the primary consideration for many welds, it is to be appreciated that welds often have other requirements as well. For example, some types of welds may have aesthetic requirements. However, surface irregularities are commonly found in many welded components. One example of a surface irregularity in a welded component is spatter, which occurs when molten metal from a weld pool is ejected. Other surface irregularities include, for example, pores, underfills, craters, undercuts, and wavy edges that are located along an outer edge of a weld. These surface irregularities may adversely affect the visual appearance of a weld and may also create variation in weld strength.

Thus, while current welds achieve their intended purpose, there is a need in the art for a method to improve the aesthetic appearance of welds having surface irregularities.

### SUMMARY

According to several aspects a method for healing surface irregularities in a weld joint is disclosed. The method includes generating a healing energy beam by a focused energy device, where the healing energy beam includes a predefined energy density. The method also includes scanning the healing energy beam along at least a portion of a periphery of the weld joint. The weld joint includes at least an upper layer and a lower layer. The method also includes melting less than half a thickness of the upper layer of the weld joint, where the predefined energy density of the healing energy beam is based on the thickness of the upper layer of the weld joint.

In another aspect, scanning the healing energy beam further comprises scanning the healing energy beam along at least the portion of the periphery of the weld joint at a predetermined feed speed.

In yet another aspect, the predetermined feed speed of the healing energy beam is constant.

In still another aspect, the method further comprises oscillating the healing energy beam along at least the portion of the periphery of the weld joint.

In an aspect, the method further comprises scanning the healing energy beam along an outer periphery of the weld joint.

In another aspect, the method further comprises scanning the healing energy beam along an inner periphery of the weld joint.

In yet another aspect, the method further comprises scanning the healing energy beam along an end portion of the weld joint.

In still another aspect, the method further comprises melting edges of the weld joint to less than a predefined thickness, where the predefined thickness is less than one-half the thickness of the upper layer of the weld joint.

In one aspect, a system for healing surface irregularities in a weld joint is disclosed. The system includes a focused energy device configured to generate a healing energy beam having a predefined energy density and a control module in electronic communication with the focused energy device. The control module executes instructions to scan the healing energy beam along at least a portion of a periphery of the weld joint, where the weld joint includes at least an upper layer and a lower layer, and the predefined energy density is based on the thickness of the upper layer of the weld joint.

In one aspect, the control module executes instructions to scan the healing energy beam along at least the portion of the periphery of the weld joint at a predetermined feed speed.

In another aspect, the predetermined feed speed of the healing energy beam is constant.

In yet another aspect, the healing energy beam is a laser beam, a plasma arc, or an electron beam.

In still another aspect, the control module executes instructions to oscillate the healing energy beam along at least the portion of the periphery of the weld joint.

In one aspect, the control module executes instructions to scan the healing energy beam along an outer periphery of the weld joint.

In another aspect, the control module executes instructions to scan the healing energy beam along an inner periphery of the weld joint.

In yet another aspect, the control module executes instructions to scan the healing energy beam along an end portion of the weld joint.

In one aspect, the predefined energy density of the healing energy beam is configured to melt edges of the weld joint to less than a predefined thickness, wherein the predefined thickness is less than one-half the thickness of the upper layer of the weld joint.

In another aspect, the system further comprises a galvo-mirror beam positioning system in electronic communication with the control module, where the galvo-mirror beam positioning system includes a plurality of mirrors that guide the healing energy beam.

In yet another aspect, the system further comprises an arm in electronic communication with the focused energy device, wherein arm is coupled to the focused energy device and guides the focused energy device.

In still another aspect, the healing energy beam is defocused and operates at a reduced energy density.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of the disclosed welding system for healing surface irregularities in a weld joint, where the system includes a focused energy device that generates a healing energy beam according to an exemplary embodiment;

FIG. 2A is a cross-sectioned view of the weld joint taken along section line A-A in FIG. 1, before undergoing a process for healing surface irregularities according to an exemplary embodiment;

FIG. 2B is an illustration of the weld joint undergoing the process for healing surface irregularities according to an exemplary embodiment;

FIG. 2C is an illustration of the weld joint after undergoing the process for healing surface irregularities according to an exemplary embodiment;

FIGS. 3A-3D illustrate a process for healing an exemplary weld joint, where FIG. 3A illustrates a welding path before the healing process and FIG. 3D illustrates the entire welding path after the healing process, according to an exemplary embodiment; and

FIG. 4 is an exemplary process flow diagram illustrating a method for healing surface irregularities in the weld joint according to an exemplary embodiment.

### DETAILED DESCRIPTION

The following description is merely exemplary in nature and is not intended to limit the present disclosure, application, or uses.

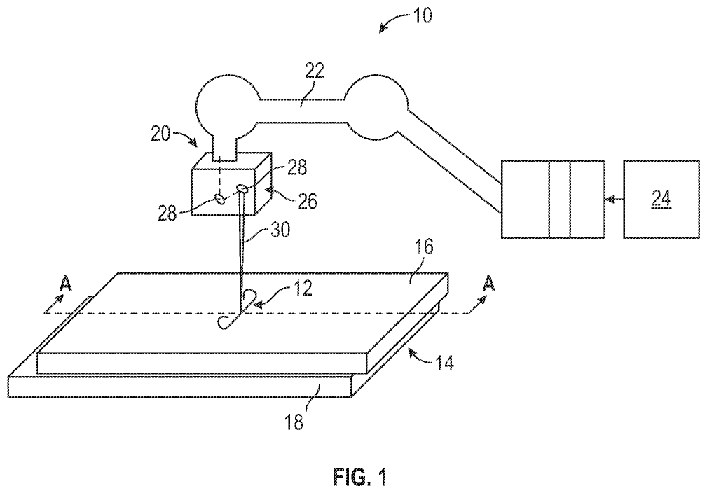

Referring to FIG. 1, a welding system 10 for healing one or more surface irregularities of a weld joint 12 is illustrated. The weld joint 12 is part of a workpiece 14, where the workpiece 14 includes an upper layer 16 and at least one bottom layer 18 that are fused together by the weld joint 12, The welding system 10 includes a focused energy device 20, an arm 22 for holding and/or guiding the focused energy device 20, a galvo-mirror beam positioning system 26, and a control module 24 in electronic communication with the focused energy device 20, the arm 22, and the galvo-mirror beam positioning system 26. The focused energy device 20 generates a healing energy beam 30 that is directed towards the weld joint 12. In an embodiment, the healing energy beam 30 is a laser beam, however, it is to be appreciated that the healing energy beam 30 may be a plasma arc or an electron beam as well. The galvo-mirror beam positioning system 26 includes one or more mirrors 28 mounted for rotation to guide the healing energy beam 30 over the workpiece 14, The mirrors 28 are separately controlled by drive assembles (not shown) in electronic communication with the control module 24. The arm 22 is coupled to the focused energy device 20 and in one embodiment also guides or manipulates the focused energy device 20 in combination with the mirrors 28. In embodiments, the arm 22 alone guides the healing energy beam 30 over the workpiece.

As explained below, the focused energy device 20 is configured to heal or smoothen one or more surface irregularities of the weld joint 12, which in turn may enhance or improve an overall aesthetic appearance of the weld joint 12 and also reduce variations in various welding properties. Some examples of surface irregularities of the weld joint 12 include, but are not limited to, spatter, pores, underfills, craters, undercuts, and wavy edges.

It is to be appreciated that the welding system 10 may be used to smoothen any type of weld joint and is not limited to any particular material or combination of materials. Specifically, the weld joint 12 may be created by any type of welding process that fuses two materials together such as, but not limited to, laser welding, arc welding, or fusion welding. It is to be appreciated that the weld joint 12 may fuse any two types of material together. Thus, the upper layer 16 and the bottom layer 18 of the weld joint 12 may be constructed of any type of material or materials that are capable of being fused by heat or by weld together. In one non-limiting embodiment, the upper layer 16 and bottom layer 18 are constructed of either steel or an aluminum alloy.

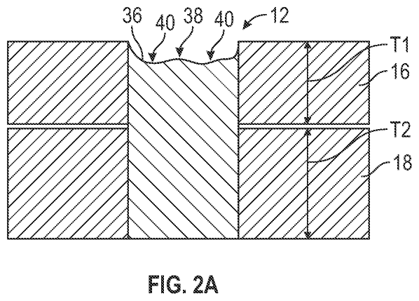

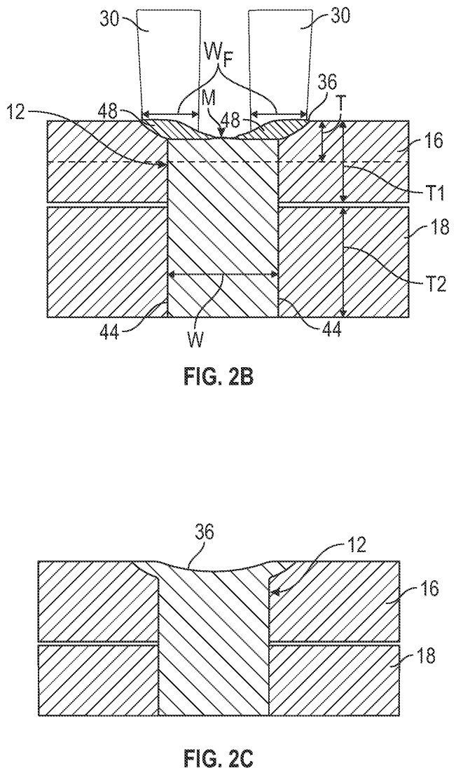

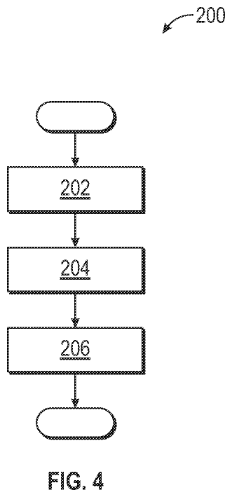

FIGS. 2A-2C illustrate the weld joint 12 shown in FIG. 1. Specifically, FIG. 2A is a cross-sectioned view of the weld joint 12 taken along section line A-A shown in FIG. 1, before undergoing a process for healing surface irregularities, which is described below and shown in FIG. 4 as method 200. FIG. 2B is an illustration of the weld joint 12 undergoing the process for healing surface irregularities. Specifically, FIG. 2B illustrates the healing energy beam 30 scanning an outermost surface 36 of the weld joint 12 according to the method 200. FIG. 2B illustrates two healing energy beams 30 in order to show that both edges 44 of the weld joint 12 are scanned when undergoing the method 200 for healing surface irregularities. The control module 24 of the welding machine 10 (FIG. 1) shares in memory a predetermined welding schedule that indicates a predetermined path that the healing energy beam 30 follows while scanning the outermost surface 36 of the weld joint 12. The welding schedule also indicates a predetermined power level and a predetermined feed speed of the healing energy beam 30 for each position along the predetermined path. FIG. 2C is an illustration of the weld joint 12 after being healed for surface irregularities. Referring specifically to FIG. 2A, one or more surface irregularities may be disposed along the outermost surface 36 of the weld joint 12. The outermost surface 36 of the weld joint 12 is exposed to an environment and may be viewed by an individual. As seen in FIG. 2A, the outermost surface 36 of the weld joint 12 has a concave profile 38 that includes one or more irregular areas 40. The irregular areas 40 represent rough, jagged features, pores, or holes that are disposed along the outermost surface 36 of the weld joint 12. It is to be appreciated that an individual may not find the irregular areas 40 disposed along the outermost surface 36 of the weld joint 12 to be aesthetically pleasing.

Referring now to both FIGS. 1 and 2B, the control module 24 instructs the arm 22 to guide the focused energy device 20 along the outermost surface 36 of the weld joint 12. Therefore, the healing energy beam 30 is scanned along the outermost surface 36 of the weld joint by the arm 22. The control module 24 executes instructions for guiding the healing energy beam 30 along the outermost surface 36 of the weld joint 12. Specifically, the control module 24 executes instructions to rotate the mirrors 28 that are part of the galvo-mirror beam positioning system 26 to guide the healing energy beam 30. In embodiment, the control module 24 also executes instructions to manipulate the arm 22 to guide the healing energy beam 30 in combination with the mirrors 28.

The control module 24 may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the control module 24 may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

Still referring to FIGS. 1 and 2B, the healing energy beam 30 includes a predefined energy density, which is based on a thickness T1 of the upper layer 16 of the weld joint 12. Specifically, as seen in FIG. 2B, the upper layer 16 of the weld joint 12 includes the thickness T1 and the lower layer 18 includes a thickness T2. In embodiments, the thickness T2 of the lower layer 18 of the weld joint is greater than the thickness T1 of the upper layer 16, however the thickness T2 of the lower layer 18 may also be equal to or less than the upper layer 16 as well. As seen in FIG. 2A, the healing energy beam 30 is directed towards and melts edges 44 of the weld joint to less than a predefined thickness T, where the predefined thickness T is less than one-half the thickness T1 of the upper layer 16 of the weld joint 12. Therefore, the predefined energy density of the healing energy beam 30 is configured to melt less than one-half the thickness T1 of the upper layer 16 of the weld joint 12. It is to be appreciated that in embodiments the healing energy beam 30 is defocused in order to operate at a reduced energy density, and thereby melts the edges 44 of the weld joint 12 to less than one-half the thickness T1 of the upper layer 16 of the weld joint 12. It is also to be appreciated that the defocusing is not necessary if the healing energy beam 30 has the appropriate energy density at its focal plane for melting the edges 44 of the weld joint 12 to less than one-half the thickness T1 of the upper layer 16 of the weld joint 12. It is also to be appreciated that values for the predetermined power level, the predetermined scan speed, and an amount of defocus of the healing energy beam 30 stored in the control module 24 (FIG. 1) are determined so that the edges 44 of the weld joint 12 are melted to less than one-half the thickness T1 of the upper layer 16 of the weld joint 12.

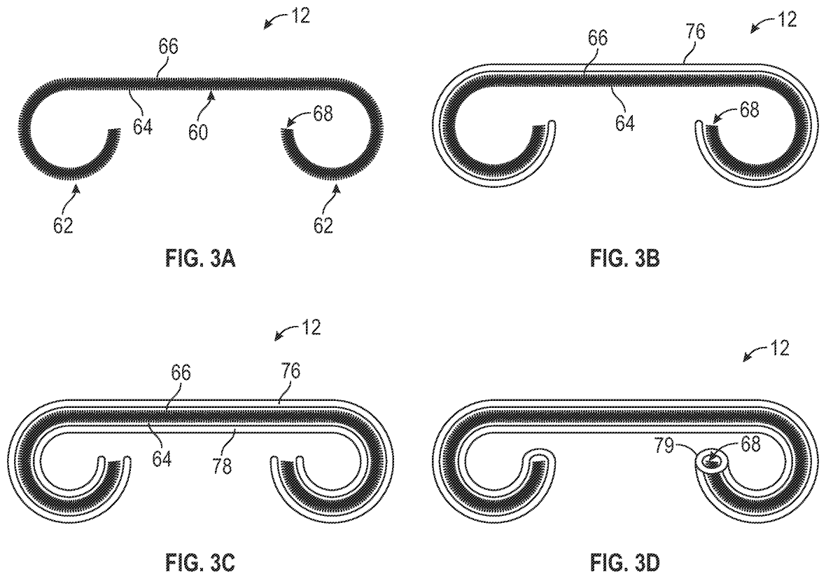

Continuing to refer to FIGS. 1 and 2B, the healing energy beam 30 includes a fusion width W_{F}, where the fusion width W_{F} is dimensioned to cover about one-half a width W of the weld joint 12. As seen in FIG. 2B, the width W of the weld joint 12 is measured between the two edges 44. The healing energy beam 30 is directed to melt material located along the edges 44 of the weld joint 12. In the embodiment as shown in FIG. 2B, the healing energy beam 30 does not substantially melt material disposed along a midpoint M of the weld joint 12, where the midpoint M is disposed between the two edges 44 of the weld joint 12. Therefore, melted material 48 along the edges 44 of the weld joint 12 may fill and smoothen the irregular areas 40 and the concave profile 38 (shown in FIG. 3A). In other words, the melted material 48 created by the healing energy beam 30 smoothens and fills in surface irregularities of the weld joint 12, thereby enhancing the overall aesthetic appearance. Thus, as seen in FIG. 2C, after the healing process the outermost surface 36 of the weld joint 12 is smooth and does not include many or all of the irregular areas 40 seen in FIG. 2A.

FIGS. 3A-3D illustrate a beam scanning path of the weld joint 12 before and after the healing process. Specifically, FIG. 3A is an illustration of a welding path for the weld joint 12 prior to healing. In the non-limiting embodiment as shown in FIGS. 3A-3D, the weld joint 12 is a laser staple weld, however, it is to be appreciated that the figures are merely exemplary in nature. Indeed, the healing energy beam 30 (FIG. 1) may be used to smoothen other types and geometries of welds as well. In the embodiment as shown, the weld joint 12 includes an elongated portion 60 and two curved sections 62, where the elongated portion 60 joins two curved sections 62 together. The control schemes ensure that the healing energy beam 30 is guided along a periphery of the weld joint 12 to melt the material located along the edges 44 of the weld joint 12 (seen in FIG. 2B) to fill and smoothen the concave profile 38 of the weld joint 12 (shown in FIG. 2A).

Referring specifically to FIG. 3A, the weld joint 12 defines an inner periphery 64, and outer periphery 66, and end portion 68, where the end portion 68 represents an end crater of the weld joint 12. In the embodiment as shown in FIG. 3D, the healing energy beam 30 (seen in FIG. 1) smoothens the entire the inner periphery 64, the outer periphery 66, and the end portion 68. However, it is to be appreciated the healing energy beam 30 may be scanned along only one of the inner periphery 64, the outer periphery 66, and end portion 68. In an embodiment, the healing energy beam 30 scans only a portion of the inner periphery 64, the outer periphery 66, and end portion 68. That is, in some embodiments, the healing energy beam 30 is scanned along only a portion of a periphery of the weld joint 12. For example, in one embodiment, the healing energy beam 30 is first guided along the outer periphery 66, then the inner periphery 64, and then the end portion 68 of the weld joint 12. As mentioned above, the control module 24 (FIG. 1) stores in memory the predetermined welding schedule that indicates the predetermined path that the healing energy beam 30 follows while scanning the weld joint 12. The welding schedule also indicates the predetermined power level and a predetermined feed speed of the healing energy beam 30 for each position along the predetermined path.

Referring to FIGS. 1 and 3B, in one embodiment the healing energy beam 30 first scans the outer periphery 66 of the weld joint 12 along a healing path 76. Then, as seen in FIG. 3C, the healing energy beam 30 scans the inner periphery 64 of the weld joint 12 along healing path 78. However, it is to be appreciated that the order may be reversed where first the inner periphery 64 is scanned. Furthermore, although FIGS. 3A and 3B indicate the healing energy beam 30 is guided along the entire inner periphery 64 and the outer periphery 66, in some embodiments the healing energy beam 30 is guided along only a portion of the inner periphery 64 or the outer periphery 66. Then, the healing energy beam 30 is scanned in a circular motion over the end portion 68 of the weld joint 12 to create a circular healing path 79. In embodiments, the healing energy beam 30 may follow the healing paths 76, 78, 79 either with or without oscillating.

It is to be appreciated that the healing energy beam 30 is scanned along at least a portion of the periphery of the weld joint at a predetermined feed speed, where the predetermined feed speed of the healing energy beam 30 is constant. In an embodiment, the predetermined feed speed of the healing energy beam 30 is greater than an original feed speed of the weld joint 12. In other words, the feed speed of the healing energy beam 30 is greater than the feed speed that is used when welding the original weld joint 12 seen in FIG. 3A. It is to be appreciated that the predetermined feed speed of the healing energy beam 30 may also be less than or equal to an original feed speed of the weld joint 12 as long as the healing energy beam 30 melts the edges 44 of the weld joint 12 to less than one-half the thickness T1 of the upper layer 16 of the weld joint 12. In one embodiment, the healing energy beam 30 is oscillated along at least the portion of the periphery of the weld joint 12, however, in some embodiments the healing energy beam 30 is not oscillated. The control module 24 (FIG. 1) instructs the focused energy device 20 to adjust the predetermined energy density of the healing energy beam 30. The control module 24 also instructs the arm 22 (FIG. 1) to adjust the predetermined feed speed of the healing energy beam 30 as well.

FIG. 4 is a process flow diagram illustrating a method 200 for healing surface irregularities of the weld joint 12. Referring now to FIGS. 1 and 4, the method 200 begins at block 202. In block 202, the focused energy device 20 generates the healing energy beam 30. The method 200 may then proceed to block 204.

In block 204, the healing energy beam 30 is scanned along at least a portion of the periphery of the weld joint 12. Referring to FIGS. 3A-3D, in one embodiment, the healing energy beam 30 smoothens the entire periphery of the weld joint 12, which includes the inner periphery 64, the outer periphery 66, and the end portion 68. The method 200 may then proceed to block 206.

In block 206, referring specifically to FIG. 2B, less than half the thickness T1 of the upper layer 16 of the weld joint 12 is melted along the healing path. As mentioned above, the predetermined power level, the predetermined scan speed, and the amount of defocus of the healing energy beam 30 are stored in the control module 24 to ensure that the edges 44 of the weld joint 12 are melted to less than one-half the thickness T1 of the upper layer 16 of the weld joint 12. The method 200 may then terminate.

Referring generally to the figures, the disclosed system and method for healing a weld joint as described provides various technical effects and benefits. Specifically, the disclosed system improves the appearance of surface irregularities that some individuals may find objectionable, thereby enhancing the overall visual appearance of a component. It is also to be appreciated that smoothening the surface of the weld joint may also enhance or improve some mechanical properties of the weld joint as well. For example, in one embodiment, the yield strength of the weld joint may be improved.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for healing surface irregularities in a weld joint, the method comprising:
generating a healing energy beam by a focused energy device, wherein the healing energy beam includes a predefined energy density;
scanning the healing energy beam along at least a portion of a periphery of the weld joint, wherein the weld joint includes at least an upper layer and a lower layer; and
melting less than half a thickness of the upper layer of the weld joint, wherein the predefined energy density of the healing energy beam is based on the thickness of the upper layer of the weld joint.

2. The method of claim 1, wherein scanning the healing energy beam further comprises:
scanning the healing energy beam along at least the portion of the periphery of the weld joint at a predetermined feed speed.

3. The method of claim 2, wherein the predetermined feed speed of the healing energy beam is constant.

4. The method of claim 1, further comprising:
oscillating the healing energy beam along at least the portion of the periphery of the weld joint.

5. The method of claim 1, wherein the method further comprises:
scanning the healing energy beam along an outer periphery of the weld joint.

6. The method of claim 1, wherein the method further comprises:
scanning the healing energy beam along an inner periphery of the weld joint.

7. The method of claim 1, wherein the method further comprises:
scanning the healing energy beam along an end portion of the weld joint.

8. The method of claim 1, further comprising:
melting edges of the weld joint to less than a predefined thickness, wherein the predefined thickness is less than one-half the thickness of the upper layer of the weld joint.

9. A system for healing surface irregularities in a weld joint, the system comprising:
a focused energy device configured to generate a healing energy beam having a predefined energy density; and
a control module in electronic communication with the focused energy device, wherein the control module executes instructions to:
scan the healing energy beam along at least a portion of a periphery of the weld joint, wherein the weld joint includes at least an upper layer and a lower layer, and wherein the predefined energy density is based on the thickness of the upper layer of the weld joint.

10. The system of claim 9, wherein the control module executes instructions to:
scan the healing energy beam along at least the portion of the periphery of the weld joint at a predetermined feed speed.

11. The system of claim 10, wherein the predetermined feed speed of the healing energy beam is constant.

12. The system of claim 9, wherein the healing energy beam is a laser beam, a plasma arc, or an electron beam.

13. The system of claim 9, wherein the control module executes instructions to:
oscillate the healing energy beam along at least the portion of the periphery of the weld joint.

14. The system of claim 9, wherein the control module executes instructions to:
scan the healing energy beam along an outer periphery of the weld joint.

15. The system of claim 9, wherein the control module executes instructions to:
scan the healing energy beam along an inner periphery of the weld joint.

16. The system of claim 9, wherein the control module executes instructions to:
scan the healing energy beam along an end portion of the weld joint.

17. The system of claim 9, wherein the predefined energy density of the healing energy beam is configured to melt edges of the weld joint to less than a predefined thickness, wherein the predefined thickness is less than one-half the thickness of the upper layer of the weld joint.

18. The system of claim 9, further comprising a galvo-mirror beam positioning system in electronic communication with the control module, wherein the galvo-mirror beam positioning system includes a plurality of mirrors that guide the healing energy beam.

19. The system of claim 9, further comprising an arm in electronic communication with the focused energy device, wherein arm is coupled to the focused energy device and guides the focused energy device.

20. The system of claim 9, wherein the healing energy beam is defocused and operates at a reduced energy density.
